(19) United States
(12) Patent Application Publication
(10) Pub. No.: US 2008/0209066 A1
(43) Pub. Date: Aug. 28, 2008

(54) Method and apparatus for providing continuous playback of media programs at a remote end user computer

(76) Inventors: Mary A. Spio, Plam Bay, FL (US); Mark E. Argenti, Kissime, FL (US); Ian B. McDaniel, Orlando, FL (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 12/011,201

(22) Filed: Jan. 24, 2008

Related U.S. Application Data
(60) Provisional application No. 60/897,103, filed on Jan. 24, 2007.

(51) Int. Cl. G06F 15/16

(52) U.S. Cl. 709/231

(57) ABSTRACT

A method and apparatus of providing programmably seamless continuous playback of a plurality of media programs at an end-user remote from a media server facility is disclosed. The method permits playing a first media program via a first video reproduction engine disposed at the media server facility and transmitting the played first media program to the first user via the Internet, before completing playing the first media program and merging the closing of the first media program and the initiated second media program at the media server facility.

### CROSS-REFERENCE TO RELATED APPLICATIONS

This application claims benefit of U.S. Provisional Patent Application 60/897,103 by Mary A. Spio, Mark E. Argenti and Ian B. McDaniel, for “METHOD AND APPARATUS FOR PROVIDING CONTINUOUS PLAYBACK OF MEDIA PROGRAMS AT A REMOTE END USER COMPUTER,” filed Jan. 24, 2007, which application is hereby incorporated by reference.

### BACKGROUND OF THE INVENTION

1. Field of the Invention

The present invention relates to systems and methods of transmitting and receiving information, and in particular to a method and system for transmitting and receiving media programs.

2. Description of the Related Art

The Internet has become an important vessel by which end-users obtain access to information and media, including audio and video information. The source of such audio and video information may be a music label, a movie studio, or may be the produced by similar end-users.

The Internet has also been responsible for allowing individuals to publish information about themselves, via blogs, and Internet websites such as MySpace and the like. The Internet has also provided the capability to widely disseminate video and other media programs. For example, through the use of a system such as YouTube, an individual may post a video, allowing millions of people to view it.

Unfortunately, although such media programs are available via the Internet, there are many limitations that impair the system's ability to provide such services in the way that user's expect before such services become competitive with similar services offered by traditional wideband broadcast sources such as broadcast television, cable, and satellite.

First, the delivery of this information places difficult demands on the user equipment and the throughput of the user's link to the Internet. While computers with significant processing and memory capabilities are becoming available all the time, a significant number of people with Internet access do not have these newer machines.

Second, the quality of the media programs and services delivered does not come even close to emulating the experience provided by traditional broadcast television, cable, or satellite.

Third, the delivery of live media program information is typically performed using streaming techniques that place significant burdens on the equipment used to transmit such programs. Typically, when a user wants to view a live media program, they select an icon or similar object on the computer screen. This transmits a message to the media server identifying the user and indicating which media program the user would like to receive. A streaming server then replicates the live video stream, and connects the requesting user to that stream. At that point, the user can receive the live media program, using this replicated stream. If another user later selects the same live video, the video server must create another replication of the media program stream, and send that replicated stream to the user. As the number of users increases, so does the number of streams. This process, which requires maintenance of one or more media streams that must always be running, is wasteful of both media server resources and communication throughput.

Traditional media delivery services also do not offer the customization and on-demand capabilities that end-users have come to expect. For example, an individual cannot use a traditional media outlet to search for, select, and play a music video of their choice. Traditional media outlets do not permit the user to generate their own playlist of media programs.

Traditional media delivery systems also do not offer the end-user the capability generate a playlist of media programs, and to allow the media programs to be webcasted to other users who might also enjoy the scheduled programming. Traditional delivery systems likewise do not permit the user to easily create and modify playlists quickly from remote locations.

In essence, the traditional broadcast and Internet media outlets have generally presented separate paradigms, each rudely modifiable to provide some approximation of the services users want, but neither well suited to the task. For example, satellite and cable television media outlets provide some modicum of interactive capability with the user, but the experience is that of a singular, well-integrated system, but rather that of a kluged system that barely works and relies on a wide variety of disparate technologies. Media services provided by typical Internet media outlets offer the ability to download media programs at reasonably rapid rates, and streaming can allow users to play media programs while they are being downloaded, but the quality of the media program presentation is low-quality, and places great demands on the user's equipment and throughput, and no Internet media source provides customizable programming that has the look and polish of a professionally assembled playlist.

What is needed is a system and method for providing media programs to users in a way that overcomes the foregoing obstacles, thus providing a media experience with the quality and ease of implementation of a traditional broadcast system, but with the versatility and customization potential of Internet-based media program providers. The present invention satisfies that need.

### SUMMARY OF THE INVENTION

The present invention solves the problems plaguing prior art systems. First, the present invention does not require the end-user to download any special purpose software, and is instead implemented with a simple browser having a media playback plugin module such as QUICKTIME, available from APPLE COMPUTER. Mixing and combining of media programs, as required to present the selected media programs in the order and in the way the user has requested, is performed by the media server or head end, not at the end-user's location. In an embodiment wherein the media programs are presented to the user in a continuous stream, the media server at the head end implements two media reproduction engines, this permitting the media server to seamlessly merge one of the media program currently playing into the second media program about to begin. Media programs are also downloaded to the end-user in a background process. Thus, while the first media program is playing, the user's end computer may be downloading the next media program.

The present invention also ameliorates throughput requirements by pre-processing media programs to segment them into transmissionally convenient portions known of the video program known as “eframes.” Such frames comprise a plurality of video frames, but less than the whole of the media program. The transmission of such a media program by sending a plurality of such eframes is less stressful on throughput requirements, and because of the packetized nature of Internet communications, can be accomplished more rapidly than the transmission of the whole video program as a single file over the same network.

In one embodiment of the invention especially applicable to live broadcasts, each of the eframes are associated with a time tag that indicates the relative “broadcast time” of the eframe. When a user requests a live video, instead of replicating the ongoing video stream, the time of the request is simply noted and used to determine which frame and subsequent frames will be sent to the user. For example, if the user requests a live video at 3:42 PM, they will be connected with the video frame associated with that time, and will be sent video frames associated with subsequent frames until such time as the user transmits a message to the video server (e.g. through their browser) indicating that they no longer wish to receive the live video. This technique does not require expensive video servers, nor does it waste processing and memory to generate a video stream every time a user requests access to the live broadcast.

The present invention avoids other problems associated with traditional broadcast and Internet media program outlets. Unlike YouTube or similar outlets, the present invention allows the user to assemble a schedule of media programs and to play those media programs continuously, one after the other, much like would have been the case if the media programs were being played on a traditional broadcast.

The present invention also includes a media program preprocessing function in which incoming candidate media programs are examined to assure the quality of the video is sufficient, that the content provider has the necessary rights to provide a license to disseminate the media program to others, and to generate metadata about the media program (e.g. keywords) so that a user searching for a media program regarding the topic of interest can find it.

The present invention also provides a user interface having a window comprising three portions. A first window portion permits the user to search for videos and to select them for playing. A second window portion permits the user to easily generate a playlist or “lineup” of videos, by simply dragging the thumbnails of the videos from the first window portion. The second window portion also permits the playlist to be modified (adding, deleting, or changing the order of the media programs in the playlist). In one embodiment, addition, subtraction, and reordering of media programs in the playlist is accomplished by using a lightweight identifier to represent each video. When the user modifies the playlist, a database resident at the media server location Navigating through by manipulating simple XML feeds that command changes to a database resident at the media server location. Since the database values determine which frames of which media programs are reproduced at any given time for any user “channel” or playlist, the user's desired playlist is implemented, while the media program itself is not copied, moved, deleted, or reorder.

In one embodiment, the invention is described as a method of providing programmably seamless continuous playback of a plurality of media programs at an end-user remote from a media server facility. The method comprises the steps of accepting a selection of a playlist having a first media program and a second media program from a first user, playing a first media program via a first video reproduction engine disposed at the media server facility, transmitting the played first media program to the first user via the Internet, before completing playing the first media program, initiating playing of the second media program, playing a second media program via a second video reproduction engine disposed at the media server facility, merging the closing of the first media program and the initiated second media program at the media server facility, and transmitting the merged first media program and second media program to the end-user.

In another embodiment, the invention can be described as a method of providing a continuous stream of a plurality of media programs to an end-user remote from a media server facility. In this embodiment, the method comprises the steps of accepting a selection of a first media program from the end-user, downloading the first media program from the media server to the end-user, playing the first media program using a browser plug in, accepting a selection of a second media program from the end-user before the transmission of the played first media program to the first user is complete, background downloading the second media program via a second video reproduction engine disposed at the media server facility, and transmitting the played second media program to the first user via the Internet.

In a still another embodiment, the invention can be described as a method of transmitting a live media program to an end-user. In this embodiment, the method comprises the steps of accepting the live media program having a plurality of interleaved frames, normalizing the live video program, adaptively de-interleaving the interleaved frames, separating the normalized live video program into a plurality of frames of transmissionally convenient size, associating each of the eframes with a time tag, receiving a request to view the live media program from the end-user at a request time, transmitting the frame of the live media program closest associated with the request time to the end-user, and transmitting further frames of the live media program associated with times subsequent to the request time to the end-user.

In yet another embodiment, the invention can be described as a method of transmitting a live media program to an end-user. In this embodiment, the method comprises the steps of accepting the media program having a plurality of interleaved frames, receiving keyword description of video program, qualifying the media program for eventual transmission according to qualification criteria including video quality and reproduction rights, adding keywords to describe program, normalizing the live video program, adaptively de-interleaving the interleaved frames, separating the normalized live video program into a plurality of eframes of transmissionally convenient size, associating each of the frames with a time tag; receiving a request to view the live media program from the end-user at a request time, transmitting the frame of the live media program closest associated with the request time to the end-user, and transmitting further frames of the live media program associated with times subsequent to the request time to the end-user.

These inventions may also be described as an apparatus comprising a means for performing the foregoing operations such as a computer and associated subsystems, or a computer readable medium tangibly embodying an instruction set for performing these operations, such as a compact disc or a DVD.

### BRIEF DESCRIPTION OF THE DRAWINGS

Referring now to the drawings in which like reference numbers represent corresponding parts throughout:

FIG. 1A is a diagram showing an exemplary embodiment of a user interface through which the end-user can play media programs;

FIG. 1B is a diagram of the page that is activated when the user logs in or selects the personalized user interface page;

FIG. 2 is a diagram of a media server facility and an end-user computer;

FIGS. 3-6 present additional interface pages that can be selected by the user; and

FIG. 7 is a diagram illustrating an exemplary computer system that can be used to implement one embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

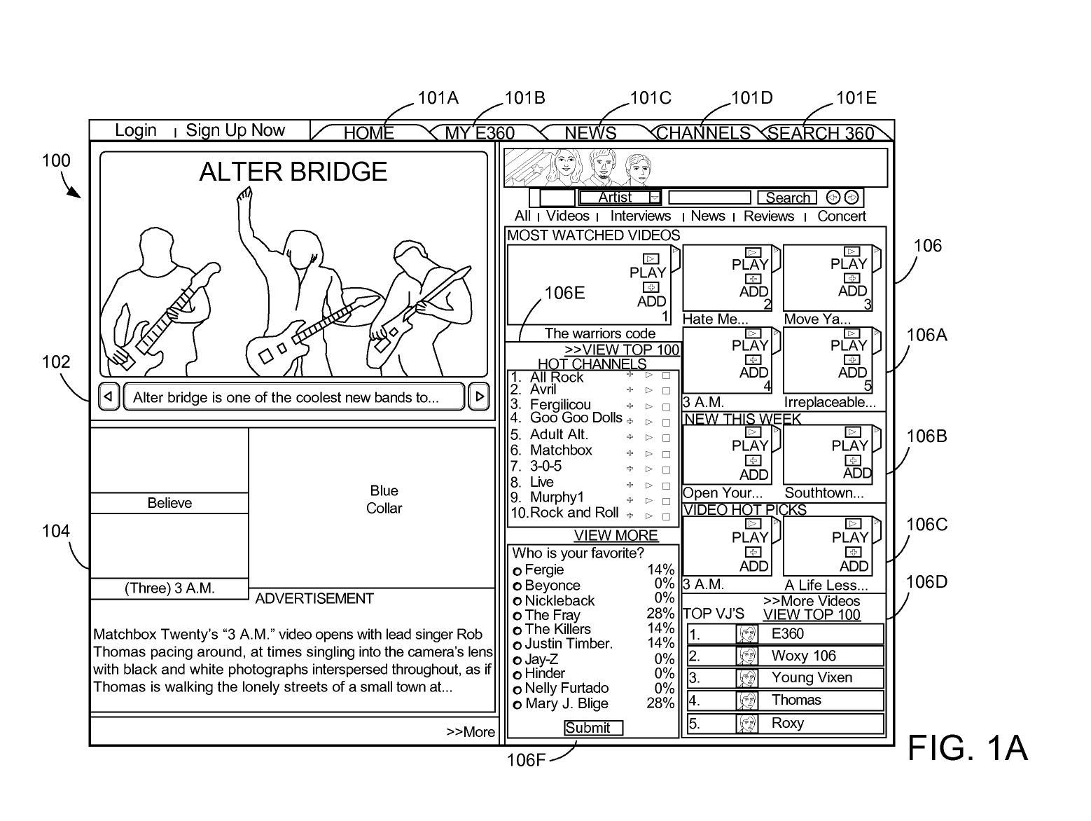

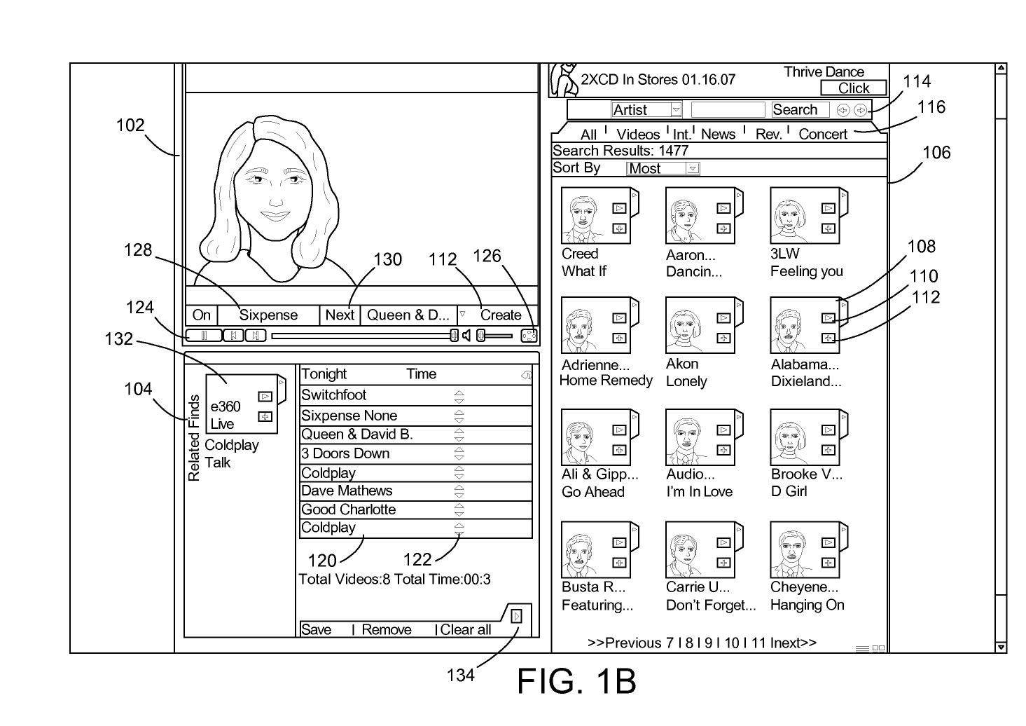

FIG. 1A is a diagram showing an exemplary embodiment of a user interface 100 through which the end-user can play media programs. Typically, the user interface 100 is presented within an Internet browser, such as one available from MICROSOFT or FIREFOX. In the illustrated embodiment, the browser window includes a set of navigation tabs 101A-101E by which the user can navigate between a home page (illustrated), a personalized page 101B, a page devoted to news and opinions 101C, a page presenting channels to the user (described further below), and a search page 101E.

In the illustrated home page (which is presented to the user before they log in), the browser window is segmented into a plurality of panes, including a first pane 102, a second pane 104, and a third pane 106. The first pane 102 comprises a media player pane, which is implemented by a media player plug-in such as QUICKTIME. In the home page, the second pane 104 is used to provide information such as advertisements. This pane 104 is used to present a user-customizable playlist pane when the personalized (My 360) page is activated. The third pane 106 is a media program selection pane 106 and includes subpanes for the most watched media programs, media programs that have been recently added, a “hot pick” pane 106C, a pane showing the top video jockeys 106D (described further below), a pane describing popular channels 106E, and a survey pane 106F.

FIG. 1B is a diagram of the page that is activated when the user logs in or selects the “My 360” tab 101B. In this page, the first pane comprises a media program player pane 102, the second pane comprises a lineup or playlist pane 104, and the third pane comprises a media program selection pane 106. The media program selection pane 106 is used to find and select media programs that the user would like to play or schedule for later playing. Different media programs are designated by icons 108. In the illustrated embodiment, icons 108 include a thumbnail of a single frame of the media program.

The user can limit the media programs that are presented in the media program selection window 106 according to a categorization which might include “videos,” “news,” “interviews,” “reviews,” “concerts,” or any similar classification. Further, the user can request to be presented with all videos complying with a particular search criteria (without respect to their categorization) by selecting “All”. In the illustrated embodiment, the user has selected “all” and is being presented with all videos. The user can also limit the videos presented in this view by performing a keyword search using the controls in the search 114 portion of the media program selection window portion 106. For example, the user can select a particular artist by selecting “artist” in the illustrated downbox, and typing in the artist of interest in the adjacent alphanumeric input box, and depressing the search button. Other possible classifications include album, song title, keyword, genre, or all (which does provides all media programs).

The media program thumbnails can be sorted using dropdown box 118 or similar control. In the illustrated example, the videos have been sorted to present those that have been the most watched first, but using the dropdown box, this can be changed to another sorting preference such as by tide, artist, or most recently added.

Once one or more media programs are presented in the media program selection pane, they may be played simply by selecting them (double clicking on the icon 108 or on a small control 110 associated with the icon 108. If the user does so, the selected video is played in the media program player pane 102.

The present invention also provides a video jockey feature which allows the user to generate, edit, and reorder a playlist of media programs, and to request that all the media programs in the playlist be played in the order indicated. In one embodiment, this is accomplished by selecting (clicking on) the icon 108 associated with the desired media program and dragging the selected icon to the lineup or playlist pane 104. As the user drags icons 108 for different media programs into the playlist pane 104, a list of the media programs is generated and displayed. This list includes the title and artist for the media program and navigation arrows 122 that can be used to promote or demote the media program in the play order. In one embodiment, a media program can be added to the playlist in a particular ordered position simply by dragging the icon 108 associated with the media program to the desired spot in the playlist. For example, in the illustrated embodiment, if the user wants to insert the “What If” media program from “Creed” into the play order after the “There She Goes” media program from “Sixpence None the Richer,” the user need only drag the icon associated with the “What If” media program to a position between the “There She Goes” media program and the following media program.

The user may also add media programs to the playlist by selecting an “add” control 112 associated with the icon 108. This adds the associated media program to the end of the current playlist.

When the user has selected all of the media programs they would like to add to the playlist, the user is saves the playlist as a “channel” that can be named, and prompted to save the playlist as a “channel.”

When adding media programs to the playlist and manipulating them, the files having the media programs remain unchanged. They are not copied or moved. Instead, each of the media programs is associated with a lightweight (small in terms of the memory required to store and manipulate it) identifier.

The information regarding the playlist is stored in the user computer as a file such as an XML file having the media program identifiers and other information. The XML file is updated when the user changes to the playlist (e.g. adding or deleting media programs from the list or changing their playing order). However, the XML file itself is not transmitted to the media server facility that will be transmitting the media programs to the user until the user indicates as such by selecting “play” or “watch” control 134, or takes some other action indicating that play should commence. Since the data describing the playlist is stored locally to the user, the interface responds quickly to user commands. Also, since what is manipulated is not the media programs themselves, but rather just identifiers and metadata associated with the media programs, the XML file is easily stored, modified, and retrieved.

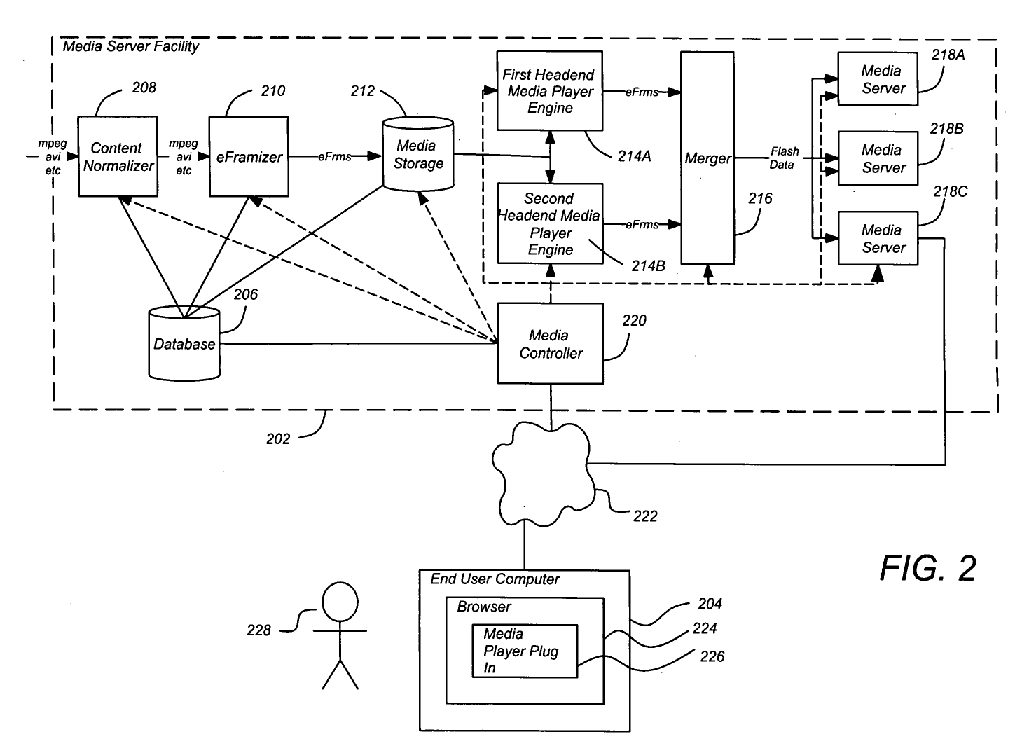

Once the user has requested that the media programs defined in the playlist begin play, the XML file is transmitted to a media controller 220 of a media server facility 202 shown in FIG. 2.

The media server facility accepts media program files (which may be in a variety of media program formats such as *.avi, *.mpg, *.wmv, preprocesses, categorizes, and controls the playback of media, and interfaces with the user's computer 204 to provide the media programs to the user 228 as requested.

Although not illustrated, before being accepted and stored in the media server facility 202, all media programs files are screened by a quality and license component. The quality component evaluates the media program to assure that it is of sufficient quality before allowing it to be stored for later dissemination. The license component assures that the appropriate licenses to copy, distribute, or otherwise use the media program have been obtained. This prescreening process ameliorates the significant copyright issues with other video serving systems such as YouTube, which are not examined before publishing to assure an author's rights to the would not be violated by making the media program available.

Next, the media program files are normalized by a content normalizer 208. The normalizer 208 processes the files associated with the accepted media programs to equalize the loudness of the soundtrack, the brightness, contrast, and color of the video, and any other parameters necessary so that the transition from one media program to another as seamless as possible. The normalizer 208 also eliminates black (empty) frames and may also insert data and information that is required by the media server facility 202 to find and categories media program files.

The resulting files are provided to an eframizer, which segments the media program files into “eframes.” As described above, such frames comprise a plurality of video frames, but less than the whole of the media program. In one embodiment, the eframes comprise approximately 8 seconds of media program information as well as metadata describing the media program within that eframe. The metadata can be sourced from the source of the media program or may be added by the media server facility 202.

The eframing process may also include compression techniques, including adaptive de-interleaving. It is known that video data (particularly video data from life feeds) is often interleaved to allow the data to be presented at lower rates without appearing to flicker. When interleaving, the odd lines of a raster-scanned video image are reproduced from top to bottom first, and then the even lines are reproduced, also from top to bottom. This increases the visual update rate of the frame and prevents flickering.

As an optional part of the eframing process, single video frames that are interleaved can be examined to determine if the information in the current video frame is substantially similar to the information in the next frame. If this is the case, the addition of the second interleaved frame is redundant, and can be removed without loss of video quality, thus offering additional video compression. Because the image is further compressed without loss of quality, additional video data can be provided to reproduce the video images, thus increasing the quality of the media program transmitted to the user. This technique permits the resolution of the video image to be approximately 50% larger than typical video provided via the Internet.

The transmission of a media program by sending a plurality of such eframes is less stressful on throughput requirements, and because of the packetized nature of Internet communications, can be accomplished more rapidly than the transmission of the whole video program as a single file over the same network. Segmenting the media program into eframes also resolves some difficulties with streaming live video, which are discussed further below.

The eframes are indexed and provided to a media storage device 212, where they are stored. If the media program is a live feed, the e-frames are time-tagged as well. The media storage device 212 may be one or more of the media servers 218 described further below.

One or more of the foregoing operations of the content normalizer, eframizer, and media storage device are controlled by the media controller 220. Database 206 is used to store information regarding the accepted (and optionally rejected) media programs, the parameters used to normalize the media program content, eframe indices and metadata, and information required to store and retrieve eframes of media programs. The media controller 220 interfaces with the database to obtain the information required to manage and control the operation of the normalizer, eframizer, and media storage device 212. Database 206 also stores XML files received from the user's computer 204 that describe the user's preferences and playlists (channels). When a user modifies a playlist or channel and transmits the modified playlist or channel to the media server facility by selecting the “play” or “watch it” control, the media controller 220 updates the database 206 to reflect the user's new playlist. Significantly, this does not involve the copying, addition, or deletion of any of the media program files. Instead, only the database 206 is updated. This allows changes to be made to user's playlists, without overwhelming processing overhead. The XML file can also be used to identify videos that the user would like to play one at a time.

### Playback of Single Pre-Recorded Media Program

When a media program is selected for playback, at least a portion of the user's XML file is transmitted to the media controller, and used to modify the information stored in the database 206 describing the user's account. In particular, if a single prerecorded media program is selected for playback, the identifier associated with that media program is provided in the XML file from the end user computer 204 to the media controller 220, and this information is used to update the user's information regarding in the database to reflect that the media program in question has been selected for a single play. The media controller 220 retrieves the identifier associated with that media program, and directs the media storage device 212 to provide the associated media program to either the first or the second media player engine 214. The output of the engine is a series of eframes that will be sent to the user's computer for playback.

In one embodiment, the media server facility 200 includes a variety of media player engines, at least one for each of the popular media types, including for example, a WINDOWS media player, REAL media player, and/or QUICKTIME media player. In one embodiment, the XML file includes an indication of the user computer's preferred media program forma, and the selection from the plurality of media players is made based upon this preference. For example, if the media player plug-in 226 to the browser 224 of the end-user's computer 204 is a QUICKTIME media player, the first headend media player engine is a QUICKTIME engine, and the resulting data stream is a QUICKTIME flash stream. Since only a single media program has been selected, the merger element 216 is not used, and the flash data is provided to one or more media servers 218, which transmit the data to the end-user's computer 204 via the Internet 222.

### Playback of Playlist of Pre-Recorded Media Program

As described above, the present invention can also be used to implement a VJ (video jockey) functionality, wherein the user may program a playlist of media programs that are seamlessly played back, one after the other, without interruption. In one embodiment, this feature is implemented as follows.

Using the techniques described above the user selects media programs to be members of an ordered playlist. The playlist will include, for example, a first media program and a second media program, with the first media program selected to play before the second media program. The result of this selection and ordering is an XML file generated in the end user's computer 204 that is transmitted to the media server facility 202 when the “watch it” control 134 is activated.

The media controller 220 uses the XML file to update the data in the database describing the user's playlist and whether the playlist should play. Using this updated information, the media controller commands the media storage device to provide the eframes of the first media program to the first media player engine 214A. The engine generates eframes of media data in the appropriate format (e.g., as specified by the XML file transmitted from the user's computer 204), and provides those eframes to the merger 246. The merger combines the information in the first eframes obtained from the first media player engine 214A with the information in the eframes from the second media player engine 214b to generate the eframe data that is transmitted to the end-user's computer and presented in the media player plug-in 226 of the browser 224.

The database 206 includes information describing the length of each media program stored in the media storage device 212. As the playback of the first media program is nearing completion, the media controller 220 commands playback of the second media program (the next media program in the user's playlist), while the playback of the first media program is still ongoing. The merger 216 merges the information in the eframes from the first media player engine 214A and the second media player engine 214B. By having two separate and independent media player engines, each handling temporally adjacent media programs in the playlist, the transition from the playback of the first media program to the second media program in the playlist is seamless. In fact, if desired, the media controller 220 may slightly overlap the media programs so that a fade out of the first media program is concurrently presented with the fade-in of the next media program. This overlap can also be user-controllable via the XML file.

Of course, once the first media program has completed play, it is available to playback a third media program to allow a seamless transition from the second media program to the third media program, should there be a third media program in the playlist.

Note that the content normalizer 208 also plays a key role in the seamless transition from one media program to another. Because the content normalizer 208 has normalized the audio volume, brightness, and other factors of the media programs stored in the media storage device 212, the transition from one to the other is made less abrupt.

The foregoing process can be optionally improved by caching portions of the media programs to be presented, particularly the beginning and ending of the media programs.

### Playback of Live Video Feeds

The media server facility 202 can also be used to playback live video feeds. Existing systems that rely on expensive and complex streaming servers. Such streaming servers maintain an active stream of the media program at all times. When a user attempts to retrieve a live feed, the streaming server replicates that stream, and connects the user to the replicated stream. Unfortunately, this solution requires expensive and complex streaming servers, and is requires potentially thousands of replications of the stream, placing great demands on memory and processing requirements.

The media server facility 202 resolves this problem, by segmenting the media program into a plurality of eframes, and associating each eframe with a time tag that describes the time for which the eframe data is relevant. When the user requests access to a live feed, the time of the request is noted, and using data available in the database 206, the media controller instructs the media storage device 212 to provide the e-frame associated with the time of the request. Thereafter, the end-user's computer 204 is also sent eframes that have time tags subsequent to the initially transmitted eframe.

For example, a life feed is optionally content normalized, segmented into e-frames (to which metadata can be added) and the eframes are time-tagged and indexed. The eframes are stored in the media storage device while the indices and metadata is then stored in the database for later use in finding and retrieving the eframes related to the life feed. If no user requests that live media program, nothing more is done (it is not streamed), because it is not requested. If a user 228 requests the live feed at 3:28PM, the media controller 220 accesses the database 206 to find the eframe having the portion of the media program associated with 3:28 PM, and instructs the media storage device 212 to provide that eframe to the merger and media server for transmission to the end-user's computer 204. Using information from the database, the media controller 220 also instructs the media storage device 212 to provide the eframes associated with all subsequent times, until playback of the media program is discontinued. If a third user requests the live feed at 4 PM, that user will be provided with eframes associated with the 4 PM time tags and those subsequent.

Using this technique, media program streams need not be replicated. Instead, a single “thread” is used, and users are sent those portions of the “thread” that are required to provide the live media program.

### Headend Data Replication

As shown in FIG. 2, the media server facility 202 may include a plurality of media servers 218A-218C. These servers allow the media server facility 202 to provide media programs to a large number of users at the same time. Although only three media servers are illustrated, there may be ten or more media servers, each tied together and serving video at any time.

Each of the media servers 218A-218C is capable of handling a given number of users, for example, 100,000 users. When the number of approaches the maximum value, the media server 220 commands the servers to allocate their capabilities to a subset of the current users. In one embodiment, the split is geographically based. That is, if there are 110,000 users throughout the United States, the media controller 220 will assign some number of users (less than 100,000) to one server and the remaining number of users (again, less than 100,000) to the second server. For example, all users west of west of the Mississippi River may be assigned to the first server, while all users geographically located east of the Mississippi River may be assigned to the second server. If these servers approach their maximum number of users, the ten media servers 218 may be geographically split again as required to service a smaller number of users in a smaller geographical area. Although media server duties could be apportioned differently (i.e. not on a geographical basis), the geographical split is convenient because it correlates to time zones and permits a simple, straightforward means for identifying which services are provided to which users via which media servers.

### Additional User Interfaces

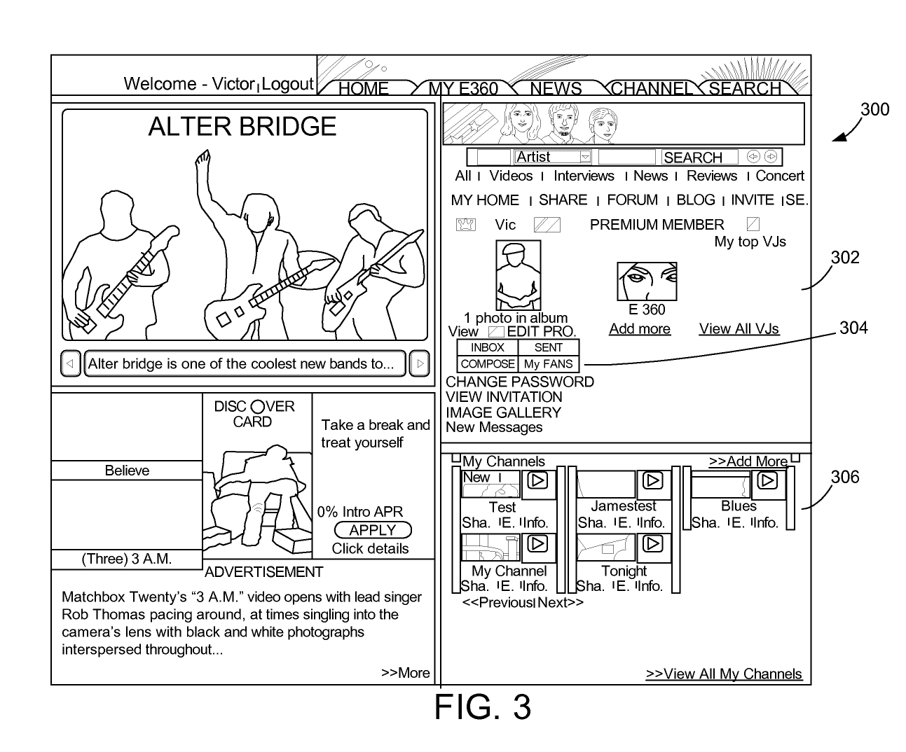

FIGS. 3-6 present additional pages that can be selected by activating tabs 101B-101E. FIG. 3 is a diagram showing an embodiment of a personalized user interface 300. In this embodiment, the media selection pane includes controls 304 that the user can use to check their mail inbox, mail outbox, compose messages, or obtain a listing of their fans (other users who have indicated that they enjoy the user's playlists or channels). The controls also allow the user to change their password, view invitations to see other user's personal pages or channels, examine images, or look only for new messages or comments. A portion 302 lists VJs that the user has identified as their favorites. Another portion 306 of the pane presents the user's favorite channels, as identified either by the user directly, or determined by monitoring the channels the user watches.

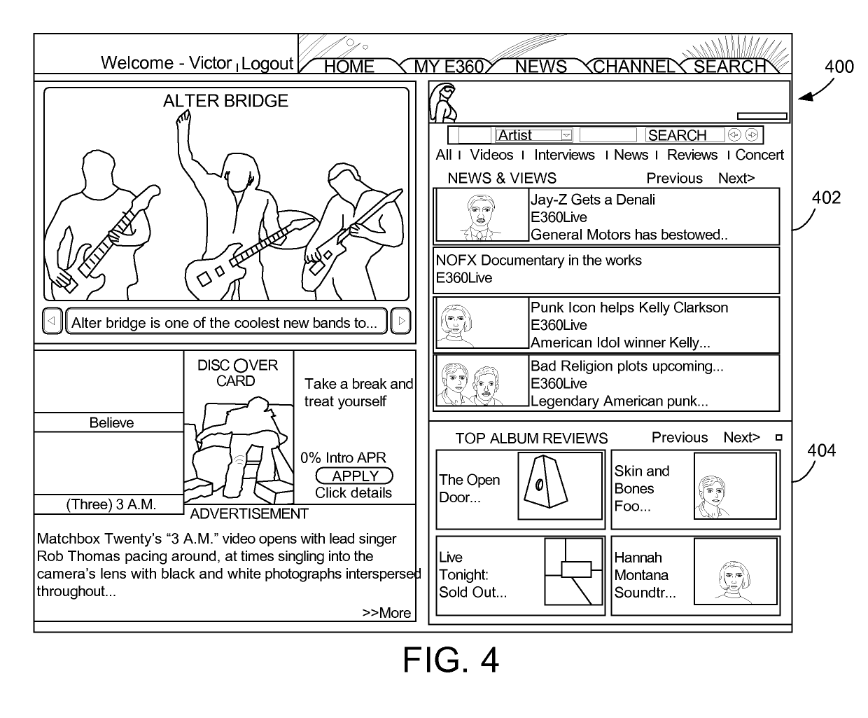

FIG. 4 is a diagram of an embodiment of the news and views page 400. The page 400 has a section describing entertainment news 402 and another section providing album reviews 404.

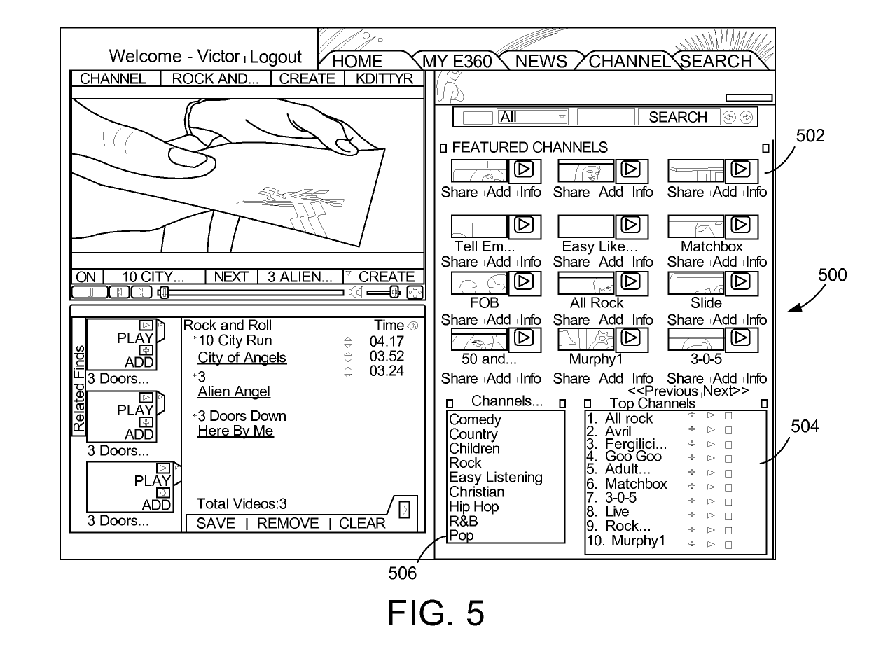

FIG. 5 is a diagram of the channels page 500. It lists featured channels 502, channels by genre 506, and top channels 504.

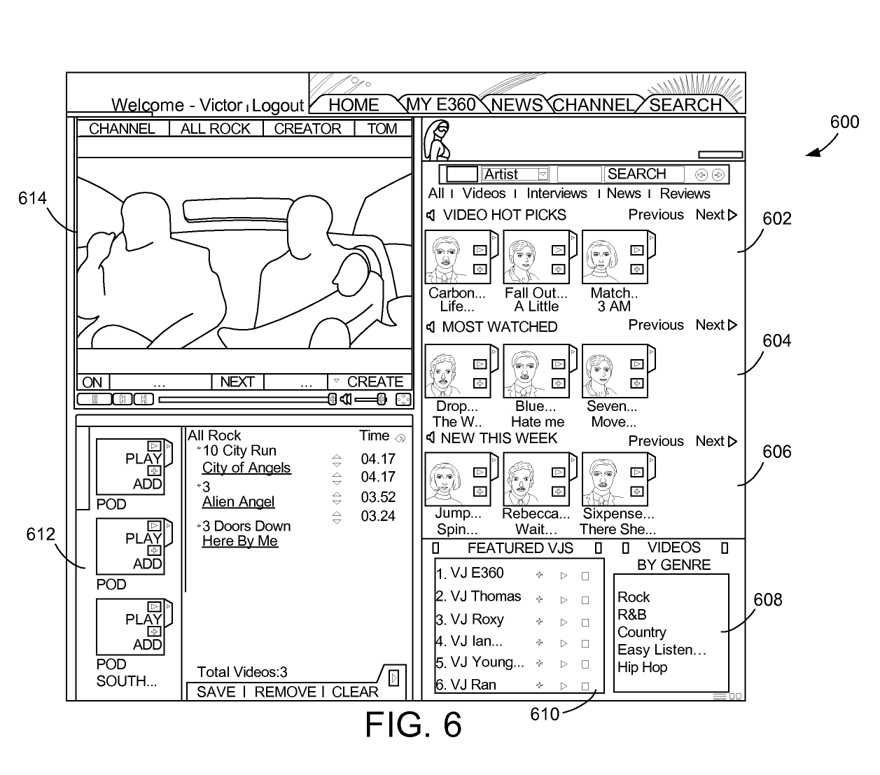

FIG. 6 is a diagram of the search 360 page 600. This page helps the user search to find videos of interest, and includes a video hot picks section 602, a most watched videos section 604, and a new video section 606. It also has a section 608 that permits the user to search for videos by genre, and a featured VJ section 610. Note that as was true with pages described above, the use may search for media programs or perform any of the above functions described in FIGS. 3-6 while watching a single media program or a playlist of media programs. Hence, the media player pane 102 and playlist pane 104 are still shown.

### Hardware Environment

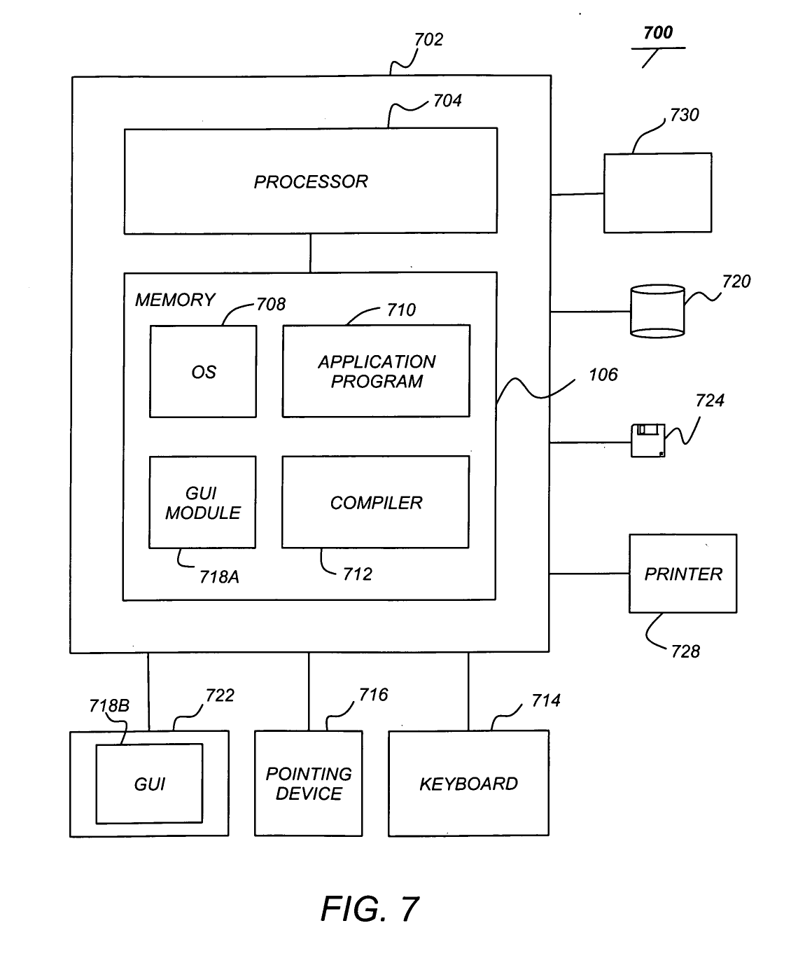

FIG. 7 illustrates an exemplary computer system 700 that could be used to implement the present invention. The computer 702 comprises a processor 704 and a memory, such as random access memory (RAM) 706. The computer 702 is operatively coupled to a display 722, which presents images such as windows to the user on a graphical user interface 718B. The computer 702 may be coupled to other devices, such as a keyboard 714, a mouse device 716, a printer, etc. Of course, those skilled in the art will recognize that any combination of the above components, or any number of different components, peripherals, and other devices, may be used with the computer 702.

Generally, the computer 702 operates under control of an operating system 708 stored in the memory 706, and interfaces with the user to accept inputs and commands and to present results through a graphical user interface (GUI) module 718A. Although the GUI module 718A is depicted as a separate module, the instructions performing the GUI functions can be resident or distributed in the operating system 708, the application program 710, or implemented with special purpose memory and processors. The computer 702 also implements a compiler 712 which allows an application program 710 written in a programming language such as COBOL, C++, FORTRAN, or other language to be translated into processor 704 readable code. After completion, the application 710 accesses and manipulates data stored in the memory 706 of the computer 702 using the relationships and logic that was generated using the compiler 712.

In one embodiment, instructions implementing the operating system 708, the computer program 710, and the compiler 712 are tangibly embodied in a computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of instructions which, when read and executed by the computer 702, causes the computer 702 to perform the steps necessary to implement and/or use the present invention. Computer program 710 and/or operating instructions may also be tangibly embodied in memory 706 and/or data communications devices, thereby making a computer program product or article of manufacture according to the invention. As such, the terms “article of manufacture,” “program storage device,” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

### Conclusion

In summary, the present invention offers the following advantages and features unknown in the prior art:

Seamless Transition of High Quality Digital Content: By using multiple players stacked behind each other, and pre-caching digital content, the present invention is able to automate the playback of multiple content. By superimposing the trailing end of one clip over the leading edge of the next clip in user's selection, and updating content in real-time, seamless transition from the playback of one media program to another is provided without requiring users to click ‘play’ each time a clip ends in order to activate the next

By pre-conditioning and normalizing all signal levels of digital files prior to upload, content is displayed seamlessly from clip to clip, without trailing or leading dark spaces or mismatched audio levels ultimately giving the user a relaxed Tv-like experience over the web, or on user's computer, portable or mobile device for unlimited content types.

Drag-n-Drop: Media programs and other digital content is grouped into datatypes by setting an identifier that characterizes how each type of file is to be handled. These files are then mapped/linked to digital thumbnails or placeholders that are presented to the user in the user interface. These place holders allows items to be draggable items that become controls that can be moved around the page, while drop targets are controls that act as “containers” for draggable items. Upon dragging the thumbnail, the linked digital content is accessed, and instantiated at runtime. Items can thus be dragged directly unto playback devices (containers), as well into lineups for instant sorting and playback.

Video Automation: By linking content to pre-defined actions, buttons on the User Interface trigger various actions at run time.

Seamless Inter-Cutting Of Various Types Of Digital Content: Different types of media programs and digital content can be played continuously. For example, an audio clip can be scheduled to play after a video clip or any other digital content without interruption. This is done by data maps, which have predefined code that tells player how to manage various types of content that's fed to the player. All content audio, video, text are all normalized to presets to ensure that seamless intercutting can occur, i.e. so that audio clips are not louder that video clips.

Demographic/Psychographic and Affinity Serving of Content: Backend provides data capture which offers genre-based, psychographic, anthropological, and demographic content targeting, making it ideal for advertisers to accurately target and reach their key consumers. By predefining affinities based on various user profiles, the present invention allows real-time targeting of advertising. For example, based on extensive characterization maps, a user selecting a John Mayer song can be served an ad based on the specific priorities with the look-up table. All content is cross-mapped to related items, and served in real time, related content, and relevant advertising.

Frame-to-Frame Time of Day Broadcast & Targeted Ad Feature: By using eframe content packaging and management, the present invention is able to provide real-time broadcast of content. Metadata is packaged with eframe data and downloaded to the user on a time or frame axis (e.g. eframe tagged for a time to is downloaded to the requesting user at time t₀. The main difference being that currently most content is streamed over the web, this limits the quality of the presented media. Further, if the connection is bursty, the viewing quality becomes degraded. Finally, a constant media stream has to be maintained regardless of whether a user is connected to the stream, which is extremely wasteful of bandwidth.

By repacking the media program into eframes and mapping to a time to run, the present invention enables real-time broadcast of content without streaming content in real-time, but rather through a dynamic download. The frame-to-frame packaging also enables inclusion of adverting. For example an advertiser's message can appear as an interstitial, substantial or supersticial at the very moment that the advertiser's product appears on screen in a playing video—an enhanced form of product placement. It also makes it possible to frame-accurately include metadata and ancillary information for playback to end-users.

Online Sorting—Realtime: Using an XML Feed, so there is no saving, we are able to move linked objects—in realtime, like an application without having to save.

Post Clip Activation Actions: The playlist functionality of the present invention enables online code-based triggering of digital clips, as well multiple post-clip activation actions. Users can elect to have playback media programs in user playlist loop, and pause, stop or move on to next media program seamlessly after activation.

Community Based and Interactivity: The present invention allows multiple users to watch programs while simultaneous interacting with each other via chat and other community functions. This is ideal for distance learning, large company training programs, medical applications, sporting programs and much more.

Scalable Architecture: By incorporating a scaling infrastructure with a user-friendly interface for unbundled entertainment programming, regardless of the screen size, the present invention is ideal for distributing all types of content; from music videos, to movies to online games.

User creating and Sharing of TV Channels Online: The present invention allows users to create “channels” or playlists in real-time, by dragging linked objects into a lineup. Users can the save their channels, the playback then displays it on the user's computer monitor just like TV. Users can also share their channel with others either by sending information individually to selected users, or by publishing the channel to all users or groups of users.

What is claimed is:

1. A method of providing programmably seamless continuous playback of a plurality of media programs at an end-user remote from a media server facility, comprising the steps of:
accepting a selection of a playlist having a first media program and a second media program from a first user;
playing a first media program via a first video reproduction engine disposed at the media server facility;
transmitting the played first media program to the first user via the Internet;
before completing playing the first media program, initiating playing of the second media program, playing a second media program via a second video reproduction engine disposed at the media server facility;
merging the closing of the first media program and the initiated second media program at the media server facility; and
transmitting the merged first media program and second media program to the end-user.

2. The method of claim 1, wherein the selection is recorded in an XML file.

3. The method of claim 2, further comprising the step of transmitting the XML file to the media server facility to initiate playback of the playlist;

4. The method of claim 1, wherein the first media program and the second media program is selected via a user interface presented on a browser on the user's computer, the user interface comprising:
a media program selection pane, for searching for and identifying media programs from a set of available media programs and for presenting a plurality of icons representing the searched and identified media programs;
a lineup pane, for indicating which of the searched and identified media programs belong to the playlist,
a playback pane, for playing back media programs in the playlist.

5. The method of claim 4, wherein the media programs are added to the playlist by dragging icons representing the searched and identified media programs from the media program selection pane to the lineup pane.

6. The method of claim 4, wherein the media programs are added to the playlist by selecting a control in the media program selection pane associated with the desired media programs.

7. The method of claims 5 or 6, wherein the selection or dragging of an icon to add a media program to the playlist modifies a file stored in the user's computer describing the user's playlist.

8. The method of claim 7, wherein playback of the playlist is initiated by transmitting the file to the media server facility.

9. The method of claim 7, wherein the file describing the user's playlist is stored in a database stored at the media server facility.

10. The method of claim 4, wherein the user can make the playlist public to allow other users to play the media programs on the playlist.

11. The method of claim 4, wherein the user's playlist may be designated as a favorite playlist of other users according to the frequency that the user's playlist is selected.

12. The method of claim 11, wherein the favorite playlist is presented to other users along with popular playlists.

13. A method of providing a continuous stream of a plurality of media programs to an end-user remote from a media server facility, comprising the steps of:
accepting a selection of a first media program from the end-user;
downloading the first media program from the media server to the end-user;
playing the first media program using a browser plug in;
accepting a selection of a second media program from the end-user before the transmission of the played first media program to the first user is complete;
background downloading the second media program via a second video reproduction engine disposed at the media server facility; and
transmitting the played second media program to the first user via the Internet

14. A method of transmitting a live media program to an end-user, comprising the steps of:
accepting the live media program having a plurality of interleaved frames;
normalizing the live video program;
adaptively de-interleaving the interleaved frames;
separating the normalized live video program into a plurality of frames of transmissionally convenient size;
associating each of the eframes with a time tag;
receiving a request to view the live media program from the end-user at a request time;
transmitting the frame of the live media program closest associated with the request time to the end-user; and
transmitting further frames of the live media program associated with times subsequent to the request time to the end-user.

15. The method of claim 14, wherein the step of adaptively de-interleaving the interleaved frames comprises the step of disregarding interleaved frame if the interleaved frame is substantially similar to the previous interleaved frame.

16. A method of transmitting a live media program to an end-user, comprising the steps of:
accepting the media program having a plurality of interleaved frames;
receiving keyword description of video program;
qualifying the media program for eventual transmission according to qualification criteria including video quality and reproduction rights;
adding keywords to describe program;
normalizing the live video program;
adaptively de-interleaving the interleaved frames;
separating the normalized live video program into a plurality of eframes of transmissionally convenient size;
associating each of the frames with a time tag;
receiving a request to view the live media program from the end-user at a request time;
transmitting the frame of the live media program closest associated with the request time to the end-user; and
transmitting further frames of the live media program associated with times subsequent to the request time to the end-user.

17. The method of claim 16, wherein each eframe represents approximately 8 seconds of the media program.
